(19) United States
(12) Patent Application Publication
(10) Pub. No.: US 2025/0104676 A1
(43) Pub. Date: Mar. 27, 2025

(54) KEY WEIGHT AND KEY FOR KEYBOARD INSTRUMENT

(71) Applicant: KABUSHIKI KAISHA KAWAI GAKKI SEISAKUSHO, Hamamatsu-shi (JP)

(72) Inventor: Tsutomu YAMAGUCHI, Hamamatsu-shi (JP)

(21) Appl. No.: 18/885,004

(22) Filed: Sep. 13, 2024

(30) Foreign Application Priority Data
Sep. 21, 2023 (JP) 2023-156574

(51) Int. Cl. G10H 1/34

(52) U.S. Cl. CPC G10H 1/346; G10H 2220/221; G10H 2220/265

(57) ABSTRACT

A key weight that is mounted in a key for a keyboard instrument by being inserted from outside into a weight accommodating portion formed in the key. The key weight includes a first weight made of an elastic material, and a second weight made of a material having a larger specific gravity than the first weight and mounted in the first weight. The first weight is configured such that when the first weight having the second weight mounted therein is mounted in the weight accommodating portion by being pushed into the weight accommodating portion, the first weight is latched with inner surfaces of the weight accommodating portion in a state in which the first weight is elastically deformed by reaction forces from the inner surfaces.

### CROSS-REFERENCE TO RELATED APPLICATION

This application claims priority to Japanese Patent Application Number 2023-156574, filed on Sep. 21, 2023, the entire content of which is incorporated herein by reference.

### BACKGROUND OF THE INVENTION

### Field of the Invention

The present invention relates to a key weight which is applied to a keyboard device for a keyboard instrument, such as an electronic piano, and is mounted in a key so as to obtain a desired touch weight to be given during key depression, and a key for the keyboard instrument in which the key weight is mounted.

### Description of the Related Art

Conventionally, as a key weight and a key for a keyboard instrument of the above-mentioned type, there have been known, for example, ones disclosed in Japanese Laid-Open Patent Publication (Kokai) No. 2015-114597 already filed by the present applicant. This key weight is formed of rubber mixed with iron powder, and includes a weight body having a rectangular parallelepiped shape, and ridge portions which are formed on opposite left and right side surfaces of the weight body and each include a plurality of ridges arranged side by side in a vertical direction. On the other hand, the key is a white key extending in a front-rear direction, and has a front end thereof formed with a weight accommodating portion (weight mounting space in Japanese Laid-Open Patent Publication (Kokai) No. 2015-114597) which is open downward.

During manufacturing of the key, when the above-described key weight is mounted in the key, the key weight is pushed into the weight accommodating portion from below the key. With this, the left and right ridge portions of the key weight are elastically deformed while being sandwiched between the weight body and the left and right side walls of the weight accommodating portion, and by thrust due to returning forces of the elastically deformed ridge portions, the key weight is fixed to the front end of the key. Thus, the key weight, described above, is configured to be capable of being easily mounted in the key only by being pushed into the weight accommodating portion of the key.

In the above-described key weight, however, since the weight thereof is relatively light, response obtained by depression of a key having the key weight mounted therein is light, so that it is sometimes impossible to obtain excellent touch feeling. Further, since the above-described key weight mounted in the key is fixed to the weight accommodating portion of the key only by the thrust of the left and right ridge portions, if the returning forces due to the elastic deformation of the ridge portions are reduced e.g. by a long-term use of the keyboard instrument, there is a fear that the key weight is displaced downward or falls off the key.

### SUMMARY OF THE INVENTION

It is a first object of the present invention to provide a key weight which can impart a sufficient weight to a key such that excellent touch feeling can be obtained, and further which can be easily mounted in the key and be positively prevented from falling off the key.

It is a second object of the present invention to provide a key for a keyboard instrument, to which the key weight is stably fixed.

To attain the above first object, in a first aspect of the present invention, there is provided a key weight that is mounted in a key for a keyboard instrument by being inserted from outside into a weight accommodating portion formed in the key, including a first weight that is made of an elastic material, and a second weight that is made of a material having a larger specific gravity than the first weight and is mounted in the first weight, wherein the first weight is configured such that when the first weight having the second weight mounted therein is mounted in the weight accommodating portion by being pushed into the weight accommodating portion, the first weight is latched with inner surfaces of the weight accommodating portion in a state in which the first weight is elastically deformed by reaction forces from the inner surfaces.

According to this construction, the key weight includes the first weight made of the elastic material, and the second weight mounted in the first weight. The second weight is made of the material having a larger specific gravity than the first weight. For this reason, it is possible, compared with a case where the key weight is formed only by the first weight, to increase the weight of the key weight. Therefore, by mounting the above-described key weight having a large weight in the key, it is possible to add a sufficient weight to the key, whereby it is possible to obtain firmly responsive and excellent touch feeling when key depression is performed.

Further, when the key weight is mounted in the key, the first weight having the second weight mounted therein is inserted into the weight accommodating portion of the key. In this case, the first weight is latched with the inner wall surfaces of the weight accommodating portion in the state in which the first weight is elastically deformed by the reaction forces from the inner wall surfaces of the weight accommodating portion. As described above, during mounting of the key weight in the key, it is possible to easily mount the key weight in the key by pushing the first weight having the second weight mounted therein into the weight accommodating portion of the key, and it is possible to positively prevent the key weight from falling off the key by latching the first weight with the inner wall surfaces of the weight accommodating portion in the state in which the first weight is elastically deformed.

Preferably, the first weight includes a first weight body portion extending a predetermined length in a front-rear direction, and a second weight mounting portion provided such that the second weight mounting portion protrudes downward from a front portion of the first weight body portion so as to removably mount the second weight in the first weight.

According to the construction of this preferred embodiment, the first weight includes the above-described first weight body portion and second weight mounting portion, and by mounting the second weight in the second weight mounting portion, it is possible to set the position of the gravity center of the key weight at a location forward of the center of the key weight in the front-rear direction. Further, since the second weight is removably mounted in the first weight, by preparing a plurality of types of second weights whose weights are different, it is possible to easily adjust the weight of the key weight.

More preferably, the first weight body portion includes a second weight upper portion-accommodating portion open forward and extending in a vertical direction so as to accommodate an upper portion of the second weight, wherein the second weight mounting portion includes left and right side wall portions extending a predetermined length downward from opposite left and right ends of a front portion of the first weight body portion, and bottom wall portions and front wall portions which are provided such that lower ends of the left and right side wall portions are connected to each other and are disposed on bottom surface sides and front surface sides of the respective left and right side wall portions, and wherein the left and right side wall portions, the bottom wall portions, and the front wall portions form a second weight lower portion-accommodating portion which is continuous with the second weight upper portion-accommodating portion so as to accommodate a lower portion of the second weight.

According to the construction of this preferred embodiment, the first weight including the first weight body portion and the second weight mounting portion is provided with the second weight upper portion-accommodating portion for accommodating the upper portion of the second weight in the first weight body portion, and the second weight lower portion-accommodating portion for accommodating the lower portion of the second weight in the second weight mounting portion. The above-described second weight upper portion-accommodating portion is formed to open forward and extend in the vertical direction. Further, the above-described second weight lower portion-accommodating portion includes the left and right side wall portions extending downward from the opposite left and right ends of the front portion of the first weight body portion, and the bottom wall portions and front wall portions which are provided such that the lower ends of the left and right side wall portions are connected to each other. The second weight lower portion-accommodating portion is formed to be continuous with the second weight upper portion-accommodating portion. By accommodating the second weight in the second weight upper portion-accommodating portion and second weight lower portion-accommodating portion constructed as described above, it is possible to securely and stably mount the second weight in the first weight.

Further preferably, the second weight includes a columnar second weight upper portion extending a predetermined length in the vertical direction and having a predetermined diameter, and a columnar second weight lower portion continuous with a lower end of the second weight upper portion and extending a predetermined length in the vertical direction, the columnar second weight lower portion having a larger diameter than the second weight upper portion, wherein when the second weight is mounted in the first weight, the second weight upper portion and the second weight lower portion are accommodated in the second weight upper portion-accommodating portion and the second weight lower portion-accommodating portion, respectively.

According to the construction of this preferred embodiment, the second weight includes the columnar second weight upper portion extending the predetermined length in the vertical direction, and the columnar second weight lower portion continuous with the lower end of the second weight upper portion and having a larger diameter than the second weight upper portion. When the second weight constructed as described above is mounted in the first weight, the second weight upper portion and the second weight lower portion are accommodated in the second weight upper portion-accommodating portion and the second weight lower portion-accommodating portion of the first weight, respectively. With this, it is possible to securely and stably mount the second weight in the first weight.

Even more preferably, the second weight is formed by a plurality of types of second weights whose second weight upper portions have vertical lengths different from each other.

According to the construction of this preferred embodiment, by preparing the plurality of types of second weights whose second weight upper portions have vertical lengths different from each other, it is possible to obtain second weights having different weights, and by mounting the obtained second weights in the first weight, it is possible to easily adjust the weight of the key weight.

To attain the above second object, in a second aspect of the present invention, there is provided a key for a keyboard instrument, in which the key weight described above is mounted, wherein the key includes the weight accommodating portion which is formed to have a hollow shape open downward, and wherein side walls of the weight accommodating portion are each formed with latching protrusions which latch the key weight by being engaged with the first weight of the key weight in a state in which the key weight is accommodated in the weight accommodating portion.

According to this construction, the weight accommodating portion formed in the key has the hollow shape open downward. The latching protrusion formed on the side wall of the weight accommodating portion latches the key weight accommodated in the weight accommodating portion by being engaged with the first weight of the key weight. With this, it is possible to easily obtain the key in which the key weight is securely mounted in the state accommodated in the weight accommodating portion.

Preferably, the weight accommodating portion of the key is configured such that the key weight can be mounted in the weight accommodating portion in a state in which front and rear of the key weight are reversed.

According to the construction of this preferred embodiment, the key weight can be mounted in the weight accommodating portion of the key not only in a normal state but also in the state in which the front and rear of the key weight are reversed. For example, in the key weight formed by the first weight and the second weight, when the second weight having a larger specific gravity is mounted at a location forward of the first weight, the center of gravity of the key weight is located forward of the center of the key weight in the front-rear direction. Therefore, by mounting the key weight in the weight accommodating portion of the key not only in the normal state but also in the state in which the front and rear of the key weight are reversed, it is possible to locate the center of gravity of the key having the key weight mounted therein more rearward than the case in which the key weight is mounted in the normal state.

The above and other objects, features, and advantages of the present invention will become more apparent from the following detailed description taken in conjunction with the accompanying drawings.

### BRIEF DESCRIPTION OF THE DRAWINGS

FIGS. 1A to 1D are views of a key weight and a key for a keyboard instrument according to an embodiment of the present invention, in which FIG. 1A is an appearance perspective view of the key, FIG. 1B is a side view of the key, FIG. 1C is a cross-sectional view taken along line c-c of FIG. 1B, and FIG. 1D is a cross-sectional view taken along line d-d of FIG. 1C;

FIGS. 2A to 2C are views of the key weight, in which FIG. 2A is an appearance perspective view, FIGS. 2B and 2C are enlarged cross-sectional views taken similar to FIGS. 1C and 1D;

FIGS. 3A and 3B are perspective views of the key weight in a state in which a second weight is removed from a first weight, in which FIG. 3A shows a state as viewed from the front and obliquely above and FIG. 3B shows a state as viewed from the rear and obliquely below;

FIG. 4 is a view corresponding to FIG. 1C, which is useful in explaining respective sizes of a weight accommodating portion of a key body and the key weight;

FIGS. 5A to 5C are views sequentially showing procedure steps of mounting the key weight in the key body, in which FIG. 5A shows a state before the key weight is inserted into the weight accommodating portion, FIG. 5B shows a state in which protrusions of the key weight are in contact with a top wall of the key body, and FIG. 5C shows a state in which the key weight is accommodated in the weight accommodating portion; and

FIG. 6A is a side view of the key which has the key weight mounted in the key body in a state in which the front and rear of the key weight are reversed, and FIG. 6B is a cross-sectional view taken similar to FIG. 1D.

### DETAILED DESCRIPTION OF PREFERRED EMBODIMENTS

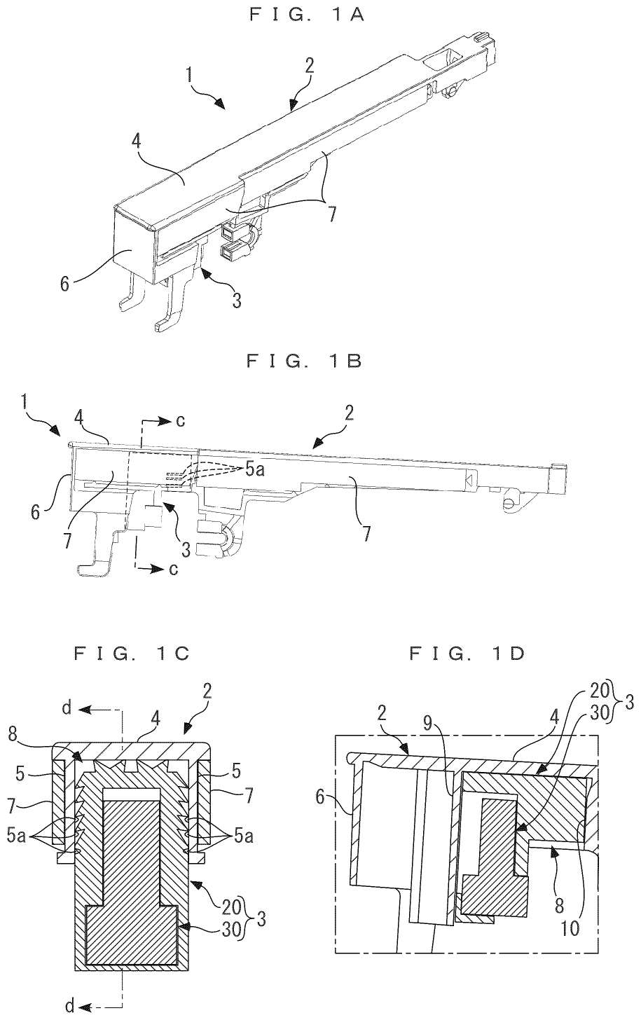

The present invention will now be described in detail with reference to the drawings showing a preferred embodiment thereof. FIGS. 1A to 1D show a key in which a key weight according to an embodiment of the present invention is mounted.

As shown in FIGS. 1A to 1D, the key 1 is a white key used in a keyboard device for a keyboard instrument, such as an electronic piano, which is formed by arranging a multiplicity of (e.g. 88) keys 1, together with black keys, not shown, in parallel in a left-right direction. The key 1 includes a key body 2 extending in a front-rear direction (left-right direction in FIG. 1B) and the key weight 3 mounted in the key body 2.

The key body 2 is made of a predetermined kind of synthetic resin (e.g. an AS resin) and is formed as a molded article having a predetermined shape extending in the front-rear direction. Specifically, the key body 2 includes a horizontal top wall 4, left and right side walls 5 and 5 (see FIG. 1C) vertically extending downward from opposite left and right ends of the top wall 4, respectively, and a front wall 6 provided on front ends of the top wall 4 and the left and right side walls 5 and 5. Note that a reference numeral 7 indicates woody boards, which are attached to outer peripheral surfaces of the left and right side walls 5 and 5 e.g. by bonding.

Further, as shown in FIGS. 1B to 1D, the key body 2 has a weight accommodating portion 8 in a front end thereof so as to mount the key weight 3 in the key body 2 in a state accommodated in the weight accommodating portion 8. The weight accommodating portion 8 has a box shape open downward. Specifically, the weight accommodating portion 8 having a predetermined size is defined by the top wall 4, the left and right side walls 5 and 5, a rib wall 9 provided at a predetermined location rearward of the front wall 6, and a rear wall 10 provided at a predetermined location rearward of the rib wall 9.

Further, three latching protrusions 5a for latching the key weight 3 are formed to protrude from each of inner surfaces of the left and right side walls 5 and 5, with a spacing therebetween in a vertical direction. Each latching protrusion 5a extends a predetermined length in the front-rear direction and is formed into a tapered shape protruding inward. Further, out of the three latching protrusions 5a formed on each side wall 5, a lowermost latching protrusion 5a is larger and protrudes further inward than the other two latching protrusions 5a.

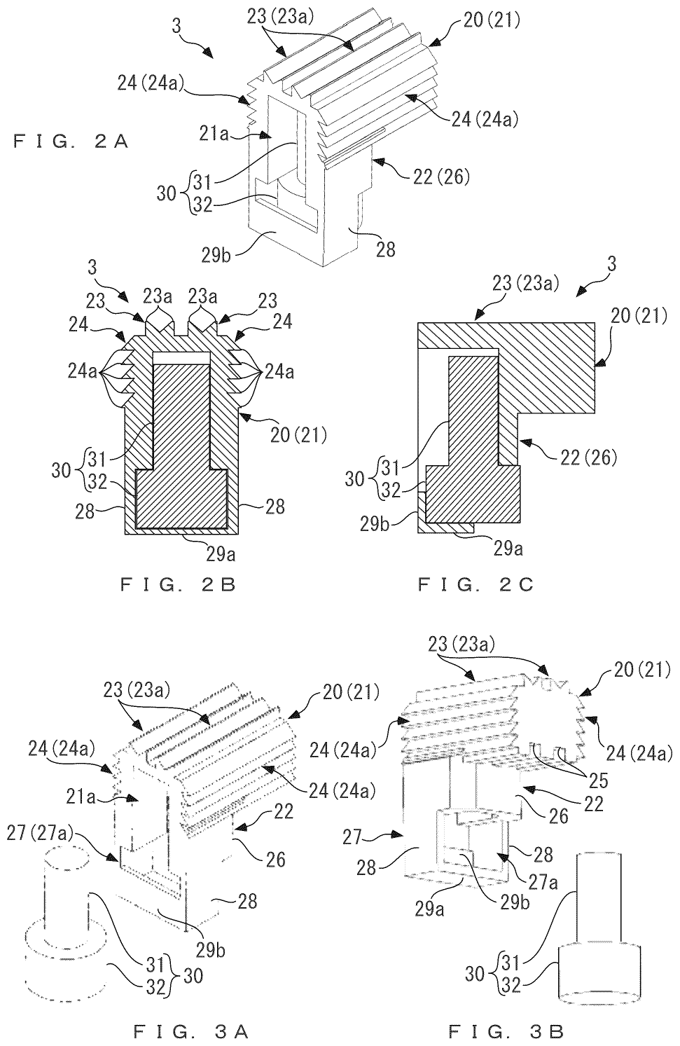

FIGS. 2A and 2B show the key weight 3, in which FIG. 2A is an appearance perspective view, FIGS. 2B and 2C are enlarged cross-sectional views taken similar to FIGS. 1C and 1D, respectively. The key weight 3 is formed by a first weight 20 made of an elastic material, and a second weight 30 made of a predetermined metal (e.g. iron) having a larger specific gravity than the first weight 20 and mounted in the first weight 20. Note that FIGS. 3A and 3B show the key weight 3 in a state in which the second weight 30 is removed from the first weight 20, in which FIG. 3A shows a state as viewed from the front and obliquely above and FIG. 3B shows a state as viewed from the rear and obliquely below.

The first weight 20 is made of an elastic material, such as a predetermined kind of rubber having a relatively large specific gravity, or rubber mixed with metal powder such as iron powder. Further, the first weight 20 includes a first weight body portion 21 extending a predetermined length in the front-rear direction and having an approximately rectangular parallelepiped shape, and a second weight-mounting portion 22 provided such that it protrudes downward from a front portion of the first weight body portion 21, so as to removably mount the second weight 30 in the first weight 20.

The first weight body portion 21 includes a second weight upper portion-accommodating portion 21a which opens forward and extends in a vertical direction so as to accommodate an upper portion of the second weight 30. Further, the first weight body portion 21 has an upper surface thereof formed with protrusions 23 protruding upward, and has opposite left and right side surfaces thereof formed with latched portions 24 which protrude outward, respectively, and are latched with the side walls 5 and 5 of the weight accommodating portion 8.

The protrusions 23 are formed by two protrusions 23 and 23 that are each formed into an M shape in front view and are arranged with a predetermined spacing therebetween in the left-right direction. Further, each protrusion 23 includes upper ridges 23a and 23a symmetrically formed and extends along the entire upper surface of the first weight body portion 21 in the front-rear direction.

Each latched portion 24 has a sawtooth shape in front view, as a whole, and is formed by five lateral ridges 24a arranged side by side along the vertical direction. Each lateral ridge 24a has a sloped surface and a horizontal surface as upper and lower surfaces and extends along the entity of an associated one of the side surfaces of the first weight body portion 21 in the front-rear direction.

Further, as shown in FIG. 3B, the first weight body portion 21 has a lower end formed with two recesses 25 open downward with a predetermined spacing therebetween in the left-right direction. Each recess 25 extends along the entire lower surface of a rear half of the first weight body portion 21 in the front-rear direction. These recesses 25 and 25 make the lower end of the rear half of the first weight body portion 21 easy to elastically deform inward in the left-right direction.

The second weight-mounting portion 22 includes a U-shaped accommodating portion 26 which is formed into a U shape in a horizontal transverse cross section (in plan view) and open forward and extends a predetermined length downward from a front half of the first weight body portion 21, and a weight support portion 27 which extends a predetermined length downward from a front half of the U-shaped accommodating portion 26 so as to support a lower portion of the second weight 30.

The U-shaped accommodating portion 26 has a predetermined thickness and has an inner surface formed flush with an inner surface of the second weight upper portion-accommodating portion 21a formed in the first weight body portion 21 formed above the U-shaped accommodating portion 26. Note that in the following description, the second weight upper portion-accommodating portion 21a includes the U-shaped accommodating portion 26.

The weight support portion 27 is comprised of left and right side wall portions 28 and 28 which extend a predetermined length downward from respective opposite left and right ends of a front portion of the U-shaped accommodating portion 26, and bottom wall portions 29a and front wall portions 29b which are provided such that lower ends of the left and right side wall portions 28 and 28 are connected to each other and are disposed on bottom surface sides and front surface sides of the respective left and right side wall portions 28 and 28. These left and right side wall portions 28 and 28 and bottom wall portions 29a and front wall portions 29b form a second weight lower portion-accommodating portion 27a continuous with the above-mentioned second weight upper portion-accommodating portion 21a so as to accommodate the lower portion of the second weight 30.

Note that the first weight 20 having the shape described above can be manufactured easily and at low costs using a relatively simple mold.

On the other hand, as shown in FIGS. 2A and 2B and FIGS. 3A and 3B, the second weight 30 includes a cylindrical second weight upper portion 31 extending a predetermined length in the vertical direction, and a cylindrical second weight lower portion 32 extending a predetermined length in the vertical direction continuously from a lower end of the second weight upper portion 31 and having a larger diameter than the second weight upper portion 31.

Note that the above-described second weight 30 is relatively easily manufactured e.g. by casting. Further, a plurality of types of second weights 30 are prepared whose weights are different due to different lengths of the second weight upper portions 31. Further, although in the present embodiment, as the second weight upper portion 31 and the second weight lower portion 32 of the second weight 30, there are employed ones both having a cylindrical shape, the second weight upper portion 31 and the second weight lower portion 32 are only required to have a columnar shape, and it is possible to employ various shapes for the second weight upper portion 31 and the second weight lower portion 32. For example, the second weight upper portion 31 can be formed into a cylindrical shape and the second weight lower portion 32 can be formed into a prismatic columnar shape, such as a quadrangular or hexagonal columnar shape, or alternatively, both the second weight upper portion 31 and the second weight lower portion 32 can be formed into prismatic columnar shapes.

In the key weight 3 formed by the first weight 20 and the second weight 30 constructed as described above, the second weight 30 is mounted in the first weight 20 as follows: As shown in FIG. 3B, the second weight upper portion 31 of the second weight 30 is inserted into an opening of the second weight-mounting portion 22 of the first weight 20, rearward of the weight support portion 27, that is, an opening formed by the left and right side wall portions 28 and 28 and the bottom wall portions 29a and open rearward, from the rear of the opening. In this case, the second weight upper portion 31 and the second weight lower portion 32 of the second weight 30 are accommodated in the second weight upper portion-accommodating portion 21a and the second weight lower portion-accommodating portion 27a, respectively, while the weight support portion 27 is being elastically deformed. With this, the second weight 30 is supported by the inner surface of the second weight upper portion-accommodating portion 21a from opposite left and right surfaces of the second weight upper portion 31 to a rear surface thereof, and is supported by an inner surface of the second weight lower portion-accommodating portion 27a from opposite left and right surfaces of the second weight lower portion 32 to the front and bottom surfaces thereof. In addition, an upper surface of the second weight lower portion 32 is brought into contact with a bottom surface of the U-shaped accommodating portion 26. From the above, the second weight 30 is mounted in the first weight 20 in a secure and stable state.

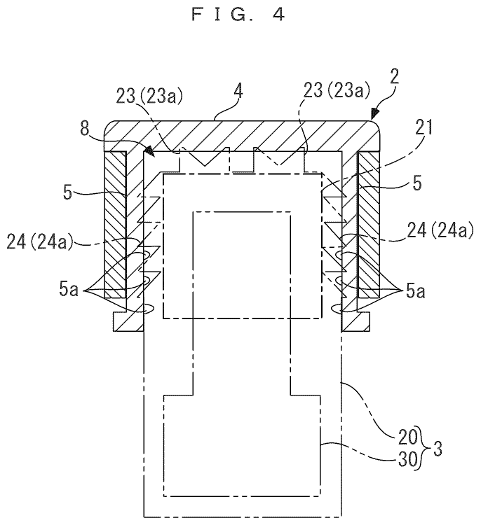

FIG. 4 corresponds to FIG. 1C, and shows the weight accommodating portion 8 of the key body 2 and the key weight 3 (indicated by two-dot chain lines) before being accommodated in the weight accommodating portion 8. As shown in FIG. 4, in the key weight 3, the first weight body portion 21 (indicated by one-dot chain lines) is formed to be smaller than the weight accommodating portion 8, and an outer shape of the first weight 20 including the protrusions 32 on the top of the first weight body portion 21 and the latched portions 24 is formed to be slightly larger than the weight accommodating portion 8.

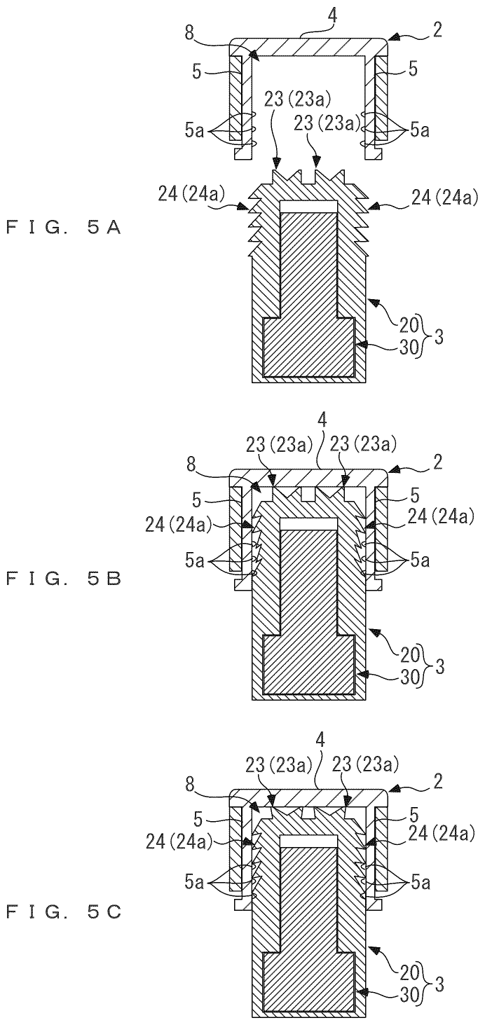

FIGS. 5A to 5C sequentially show procedure steps of mounting the key weight 3 in the key body 2. FIG. 5A shows a state before the key weight 3 is inserted into the weight accommodating portion 8. The key weight 3 is inserted into the weight accommodating portion 8 from below the key body 2. During this insertion, each lateral ridge 24a of the left and right latched portions 24 of the key weight 3 receive a reaction force from an associated one of the side walls 5 of the weight accommodating portion 8 and is elastically deformed such that the lateral ridge 24a is bent below.

FIG. 5B shows a state immediately after respective upper ends of the protrusions 23 formed on an upper end portion of the key weight 3 accommodated in the weight accommodating portion 8 are brought into contact with the top wall 4 of the key body 2. In this state, at the left and right latched portions 24 of the key weight 3, tip ends of the lowermost lateral ridges 24a are located downward of associated ones of the lowermost latching protrusions 5a of the side walls 5 of the weight accommodating portion 8. When the key weight 3 is further pushed into the weight accommodating portion 8 from this state, as shown in FIG. 5C, the upper ridges 23a and 23a of each protrusion 23 of the key weight 3 are elastically deformed such that they are bent in the left-right direction to increase a distance therebetween. Further, in this case, the left and right lowermost lateral ridges 24a and 24a of the key weight 3 get over the associated ones of the lowermost latching protrusions 5a and 5a of the weight accommodating portion 8 and are located upward of the lowermost latching protrusions 5a and 5a, whereby the lowermost lateral ridges 24a and 24a are latched with the associated lowermost latching protrusions 5a and 5a in a state supported from below by the lowermost latching protrusions 5a and 5a.

As described in detail heretofore, according to the key weight 3 of the present embodiment, the key weight 3 is formed by the first weight 20 made of the elastic material and the second weight 30 made of the metal having a larger specific gravity than the first weight 20, so that it is possible, compared with a case where the key weight 3 is formed only by the first weight, to increase the weight of the key weight 3. Therefore, by mounting the above-described key weight 3 having an increased weight in the key body 2, it is possible to add a sufficient weight to the key 1, whereby it is possible to obtain firmly responsive and excellent touch feeling when key depression is performed.

Further, when the key weight 3 is mounted in the key body 2, the first weight 20 is latched with the latching protrusions 5a in a state in which the left and right latched portions 24 and 24 are elastically deformed by the reaction forces from the inner surfaces of the left and right side walls 5 of the weight accommodating portion 8. As described above, during mounting the key weight 3 in the key body 2, the key weight 3 is pushed into the weight accommodating portion 8 of the key body 2, whereby it is possible not only to easily mount the key weight 3 in the key body 2 but also to positively prevent the key weight 3 from falling off the key body 2.

Further, according to the key 1 of the present embodiment, it is possible to easily obtain the key 1 in which the above-described key weight 3 is securely mounted in the key body 2 in a state accommodated in the weight accommodating portion 8.

Note that the present invention is by no means limited to the above-described embodiment but can be practiced in various forms. For example, although in the above-described embodiment, the key weight 3 is mounted in the key body 2 in a state in which the second weight 30 is disposed in a front portion of the key weight 3, it is also possible to mount the key weight 3 in the key body 2 in a state in which the front and rear of the key weight 3 are reversed.

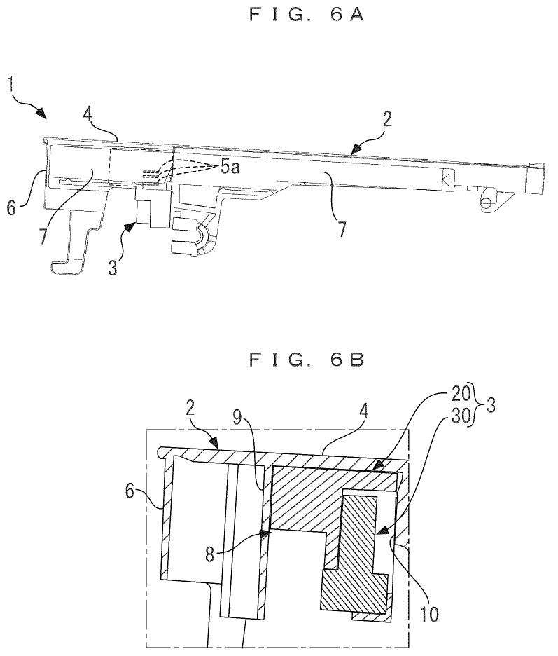

FIGS. 6A and 6B are views similar to FIGS. 1B and 1D, respectively, and show a state in which the key weight 3 is mounted in the weight accommodating portion 8 of the key body 2 in the state in which the front and rear (left and right as viewed in FIGS. 6A and 6B) of the key weight 3 are reversed. In this case, it is possible to set the position of the gravity center of the key at a location rearward of that of the above-described key 1.

Further, although in the present embodiment, rubber is used as the material of the first weight 20 and metal is used as the material of the second weight 30, by way of example, the materials of the first weight and the second weight of the present invention are not limited to these, but any suitable weight can be employed insofar as the material of the second weight has a specific gravity larger than that of the first weight. It is possible to employ various materials, such as a composite material made of metal and synthetic resin.

Furthermore, although in the present embodiment, the single key weight 3 is mounted in the key body 2, one or a plurality of key weights can be mounted in a portion or portions of the key body 2, other than the portion where the key weight 3 is mounted. With this, by making the weight of the key 2 heavier, when key depression is performed, it is possible to increase the inertia moment of the key 2 which pivotally moves about a pivot located at a rear end of the key 2 or rearward thereof. As a result, it is possible to obtain a keyboard which has firmly responsive and excellent touch feeling.

Further, details of the constructions of the key weight 3, the first weight 20, the second weight 30, and the key 1 shown in the embodiment are given only by way of example, and they can be modified as appropriate within the scope of the subject matter of the present invention.

It is further understood by those skilled in the art that the foregoing are preferred embodiments of the invention, and that various changes and modifications may be made without departing from the spirit and scope thereof.

1 what is claimed is:

1. A key weight that is mounted in a key for a keyboard instrument by being inserted from outside into a weight accommodating portion formed in the key, comprising:
a first weight that is made of an elastic material; and
a second weight that is made of a material having a larger specific gravity than the first weight and is mounted in the first weight,
wherein the first weight is configured such that when the first weight having the second weight mounted therein is mounted in the weight accommodating portion by being pushed into the weight accommodating portion, the first weight is latched with inner surfaces of the weight accommodating portion in a state in which the first weight is elastically deformed by reaction forces from the inner surfaces.

2. The key weight according to claim 1, wherein the first weight includes:
a first weight body portion extending a predetermined length in a front-rear direction, and
a second weight mounting portion provided such that the second weight mounting portion protrudes downward from a front portion of the first weight body portion so as to removably mount the second weight in the first weight.

3. The key weight according to claim 2, wherein the first weight body portion includes a second weight upper portion-accommodating portion open forward and extending in a vertical direction so as to accommodate an upper portion of the second weight,
wherein the second weight mounting portion includes:
left and right side wall portions extending a predetermined length downward from opposite left and right ends of a front portion of the first weight body portion, and
bottom wall portions and front wall portions which are provided such that lower ends of the left and right side wall portions are connected to each other and are disposed on bottom surface sides and front surface sides of the respective left and right side wall portions, and,
wherein the left and right side wall portions, the bottom wall portions, and the front wall portions form a second weight lower portion-accommodating portion which is continuous with the second weight upper portion-accommodating portion so as to accommodate a lower portion of the second weight.

4. The key weight according to claim 3, wherein the second weight includes:
a columnar second weight upper portion extending a predetermined length in the vertical direction and having a predetermined diameter, and
a columnar second weight lower portion continuous with a lower end of the second weight upper portion and extending a predetermined length in the vertical direction, the columnar second weight lower portion having a larger diameter than the second weight upper portion, and
wherein when the second weight is mounted in the first weight, the second weight upper portion and the second weight lower portion are accommodated in the second weight upper portion-accommodating portion and the second weight lower portion-accommodating portion, respectively.

5. The key weight according to claim 4, wherein the second weight is formed by a plurality of types of second weights whose second weight upper portions have vertical lengths different from each other.

6. A key for a keyboard instrument, in which the key weight according to claim 1 is mounted,
wherein the key includes the weight accommodating portion which is formed to have a hollow shape open downward, and
wherein side walls of the weight accommodating portion are each formed with latching protrusions which latch the key weight by being engaged with the first weight of the key weight in a state in which the key weight is accommodated in the weight accommodating portion.

7. The key according to claim 6, wherein the weight accommodating portion of the key is configured such that the key weight can be mounted in the weight accommodating portion in a state in which front and rear of the key weight are reversed.
